(19) United States
(12) Patent Application Publication
(10) Pub. No.: US 2014/0202953 A1
(43) Pub. Date: Jul. 24, 2014

(54) Multilayer Membrane Containing Carbon Nanotube Manufactured by Layer-By-Layer Assembly Method

(71) Applicant: GWANGJU INSTITUTE OF SCIENCE AND TECHNOLOGY, Gwangju (KR)

(72) Inventors: Heechul CHOI, Gwangju (KR); Lei LIU, Gwangju (KR); Moon SON, Gwangju (KR)

(73) Assignee: GWANGJU INSTITUTE OF SCIENCE AND TECHNOLOGY, Gwangju (KR)

(21) Appl. No.: 14/141,195

(22) Filed: Dec. 26, 2013

(30) Foreign Application Priority Data
Jan. 24, 2013 (KR) 10-2013-0008045

(51) Int. Cl. B01D 71/68; B01D 71/58; B01D 69/04; B01D 61/14; B01D 69/12

(52) U.S. Cl. CPC B01D 71/68; B01D 61/145; B01D 69/12; B01D 69/043; B01D 71/58; B01D 69/122
USPC 210/490; 427/402; 427/407.1

(57) ABSTRACT

Disclosed herein is a multilayer membrane containing carbon nanotube manufactured by a layer-by-layer assembly method, the multilayer membrane according to the present invention having excellent (i) flux property, (ii) anti-fouling (in particular, anti-protein-fouling) property, and (iii) flux recovery property by a simple water cleaning process even after the membrane is fouled.

### CROSS REFERENCE TO RELATED APPLICATION

This application claims priority to Korean Patent Application No. 10-2013-0008045 filed on Jan. 24, 2013, and all the benefits accruing therefrom under 35 U.S.C. §119, the contents of which is incorporated by reference in its entirety.

### BACKGROUND OF THE INVENTION

1. Technical Field

The present invention relates to a multilayer membrane containing carbon nanotube manufactured by a layer-by-layer assembly method, and in particular, to a multi-walled carbon nanotube composite polyelectrolyte (PEMs) membrane on a polyethersulfone (PES) porous support membrane using a spray-assisted layer-by-layer (LBL) method.

2. Description of the Related Art

In general, ultrafiltration is a pressure-driving separator technology suppressing polymer or materials having high molecular weight from being permeated and excluding bacteria and virus materials. These days, the ultrafiltration is evaluated as a promising technology for producing high quality of drinking water.

Meanwhile, despite a number of advantages as described above, the ultrafiltration has a problem in which permeance is decreased due to membrane pollution, which is the most serious and inherent problem in effectively applying the ultrafiltration. However, Diagne et al., discloses that a silver nanoparticle coating separator using a layer-by-layer (LbL) assembly method maintains an increased electric charge and hydrophilic property and imparts anti-bacterial property (Diagne, Malaisamy et al., 2012). In addition, a research into anti-bacterial property due to a copper fixing in a layer-by-layer assembly method of polyacrylonitrile ultrafiltration was reported [Xu, Feng et al., 2012].

Among various surface modified methods, layer-by-layer (LbL) assembly method is useful for multilayer thin membrane of various materials such as polymers, small molecules, and inorganic materials due to easy operation and utilization [Cerda et al. 2009]. This method allows deposition on a support due to secondary actions of electric charges [Hammond 2011]. The spray-assisted layer-by-layer (LbL) method enables mass-production without deterioration in quality of a coating layer, saves time, and minimizes an amount of used materials, which is more excellent than a dip-coating method [Izquierdo et al. 2005].

### SUMMARY OF THE INVENTION

An object of the present invention is to provide a multilayer membrane capable of having sufficiently excellent permeance property and anti-fouling (in particular, anti-protein-fouling) property, and flux recovery property by a simple water cleaning process even after the membrane is fouled.

According to an exemplary embodiment of the present invention, there is provided a multilayer membrane including: (a) a substrate, (b₁) a first layer adjacently formed on the substrate, (b₂) a second layer adjacently formed on the first layer, (b₃) a third layer adjacently formed on the second layer, . . . , and (bₙ) an nth layer adjacently formed on the (n−1)th layer, wherein the first layer to the nth layer formed on the substrate are formed by a layer-by-layer assembly method; the adjacent two layers are bound to each other by one or two or more kinds of actions selected from hydrophobic interaction or hydrophilic interaction, hydrogen bonding, electrostatic attraction (or adsorption) and van der Waals force; and at least one of the first layer to the nth layer formed on the substrate contains carbon nanotube (CNT).

### BRIEF DESCRIPTION OF THE DRAWINGS

The above and other objects, features and advantages of the present invention will be more clearly understood from the following detailed description taken in conjunction with the accompanying drawings, in which:

FIGS. 1a and 1b show a method of manufacturing a polyelectrolyte multilayer membrane using a spray-assisted layer-by-layer method;

FIG. 2 shows a Fourier-transform infrared spectroscopy (FTIR) spectrum of f-MWNCTs;

FIGS. 3(a) and 3(b) are photographs of non-functionalized MWCNT and FIGS. 3(c) and 3(d) are photographs of transmission electron microscope (TEM) images of functionalized MWCNT;

FIG. 4 is a scanning electron microscope (SEM) photographed image, wherein an arrow shows f-MWCNTs, (a) Bare PES, (b) PES-(PSS/MWCNTs-PDDA)_{3.5}, and (c) PES—(PSS/MWCNTs-PDDA)_{6.5};

FIG. 5 is a FTIR data; (a) Bare PES, (b) PES—(PSS/MWCNTs-PDDA)_{3.5}, and (c) PES-(PSS/MWCNTs-PDDA)_{6.5};

FIG. 6 is an atomic force microscope (AFM) tapping mode image of a manufactured separator; (a) PES membrane, (b) 3.5 bilayer deposition, and (c) 6.5 bilayer deposition;

FIG. 7 is a graph showing pure water flux of a polymer multilayer separator depending on transmembrane pressure function; and

FIG. 8 shows a data regarding flux loss and flux recovery of a separator manufactured for an anti-fouling test.

### DESCRIPTION OF THE PREFERRED EMBODIMENTS

Hereinafter, various aspects and embodiments of the present invention will be described in detail.

According to one aspect of the present invention, a multilayer membrane including: (a) a substrate, (b₁) a first layer adjacently formed on the substrate, (b₂) a second layer adjacently formed on the first layer, (b₃) a third layer adjacently formed on the second layer, . . . , and (bₙ) an nth layer adjacently formed on the (n−1)th layer, wherein the first layer to the nth layer formed on the substrate are formed by a layer-by-layer assembly method; the adjacent two layers are bound to each other by one or two or more kinds of actions selected from hydrophobic interaction or hydrophilic interaction, hydrogen bonding, electrostatic attraction (or adsorption) and van der Waals force; and at least one of the first layer to the nth layer formed on the substrate contains carbon nanotube (CNT) is provided.

According to an embodiment of the present invention, the layer-by-layer assembly method is performed by spraying a solvent or a dispersion of materials forming each layer on a target surface. In the case of performing other manufacturing processes and processing conditions as the same as each other and at the time of manufacturing a membrane by a spray-assisted layer-by-layer (LbL), it was confirmed that a surface roughness of the finally manufactured membrane was significantly decreased and an anti-protein fouling property among anti-fouling properties also was significantly decreased with the decrease in surface roughness, as compared to the bare substrate.

According to another embodiment of the present invention, in the first layer to the nth layer formed on the substrate, two polymer layers which are an A layer and a B layer are repeatedly formed alternately.

According to still another embodiment of the present invention, in the first layer to the nth layer formed on the substrate, three polymer layers which are an A layer, a B layer, and a C layer are repeatedly formed alternately.

According to still another embodiment of the present invention, in the case in which the repeatedly and alternately formed layers are two polymer layers, carbon nanotube is contained in at least any one of the A layer and the B layer, or in the case in which the repeatedly and alternately formed layers are three polymer layers, carbon nanotube is contained in at least any one of the A layer, the B layer, and the C layer.

According to still another embodiment of the present invention, in the case in which the repeatedly and alternately formed layers are two polymer layers, carbon nanotube is contained in only one of any one of the A layer and the B layer, or in the case in which the repeatedly and alternately formed layers are three polymer layers, carbon nanotube is contained in only one of any one of the A layer, the B layer, and the C layer.

According to still another embodiment of the present invention, a content of the carbon nanotube (CNT) in the CNT-containing layer may be 0.1 to 5 wt %.

According to still another embodiment of the present invention, the multilayer membrane may be an ultrafiltration membrane.

According to still another embodiment of the present invention, the substrate may be made of PES, the first layer may be PSS containing MWCNT, and the second layer may be PDDA; and the first layer of PSS containing MWCNT and the second layer of PDDA may be repeatedly stacked on the substrate alternately. In the case of having a different constitution from the above-described constitution, a flux is decreased to be 80% or less of the prior flux despite excessive water cleaning. Meanwhile, in the case of having the above constitution described in the present invention, the flux is recovered up to 90 to 95% of the prior flux by repeating a simple water cleaning process including immersion into a deionized water for 5 to 10 times even after the membrane is fouled.

According to another embodiment of the present invention, the substrate contacts a post-permeation filtrate filtering and permeating the multilayer membrane; the uppermost layer disposed at a side opposite to the substrate contacts a pre-permeation filtrate containing a target material to be filtered out by the multilayer membrane; in the case in which a fouling-induced material contained in the pre-permeation filtrate and adsorbed onto the multilayer membrane to induce a fouling of the membrane is negatively charged, the uppermost layer disposed at a side opposite to the substrate is also negatively charged; and in the case in which the fouling-induced material is positively charged, the uppermost layer is also positively charged.

According to still another embodiment of the present invention, the fouling-induced material is negatively charged, the uppermost layer is made of PSS/MWCNT, and in the case in which the fouling-induced material is positively charged, the uppermost layer is made of PDDA.

In the present invention, PES indicates polyethersulfone, PSS indicates poly(sodium 4-styrenesulfonate), PDDA indicates poly(diallyldimethylammoniumchloride), and CNT and MWCNT indicate carbon nanotube and multi-walled carbon nanotube, respectively.

In addition, the first and second layers alternately stacked on the substrate to form the multilayer membrane, wherein the substrate—the first layer and the first layer—the second layer are non-chemically bound to each other; and more specifically, they are bound to each other by one or two or more kinds of actions selected from hydrophobic interaction or hydrophilic interaction, hydrogen bonding, electrostatic attraction (or adsorption) and van der Waals force.

For example, in the case of using PES as the substrate, MWCNT-containing PSS (hereinafter, “PSS/MWCNT”) as the first layer, and PDDA as the second layer, PES and PSS/CNT are bound to each other by hydrophobic interaction and hydrogen bonding, and PSS/CNT and PDDA are bound to each other by electrostatic adsorption and van der Waals force.

An example of the multilayer membrane according to the present invention includes a PES-PSS/MWCNT-PDDA-PSS/MWCNT-PDDA-PSS/MWCNT membrane in which a PES substrate, a PSS/MWCNT layer, a PDDA layer, and a PSS/MWCNT layer are sequentially formed one by one, and the membrane is represented by PES-(PSS/MWCNT-PDDA)ₙ (wherein n=1.5) in addition to the above example.

The uppermost layer disposed at a side opposite to the substrate may be negatively charged or partially negatively charged like PSS, or may be positively charged or partially positively charged like PDDA. Here, “partially charged” means a case in which a molecule is dipolized in a skeleton to form dipole moment.

That is, kinds and structures of polymers formed in the uppermost layer are changed, such that kinds and intensity of the electric charges of the uppermost layer may be determined and controlled depending on application ranges and requirements, and thus, it was confirmed that membrane permeance, anti-bacterial effect, anti-fouling effect were significantly improved.

Therefore, negative charge or positive charge in the present invention may include the case of being partially negatively charged or being partially positively charged as well as the case of being 100% charged.

Hereinafter, the present invention will be described in detail through the following embodiments; however, it is not construed as limiting the scope or the spirit of the present invention. In addition, as long as a person skilled in the art practices the present invention based on the disclosed description of the present invention including the following examples, it is obvious that the present invention may be easily practiced by a person skilled in the art even though testing results are not specifically provided.

### EXAMPLE

A polyethersulfone substrate (PES20; 20,000 Da) represented by the following Chemical Formula 1 was purchased from AMFOR Inc. (USA). A multi-walled carbon nanotube (MWCNTs) was purchased from a Hanwha Nanotech (Korea). Poly(sodium 4-styrenesulfonate) (PSS, Mw=70,000 Da, powder, Sigma-Aldrich, USA) represented by the following Chemical Formula 2 and poly(diallyl-dimethylammonium chloride) (PDDA, Mw=100,000-200,000 Da, wt % in H₂O, Sigma-Aldrich, USA) represented by the following Chemical Formula 3 were purchased from Sigma-Aldrich.

Bovine serum albumin (BSA), Mw=68,000 Da having an isoelectric point of pH 4.7 to 4.9 was purchased from Roche (Switzerland). A deionized water was generated in a condition of 18.2 MΩcm using Milli-Q.

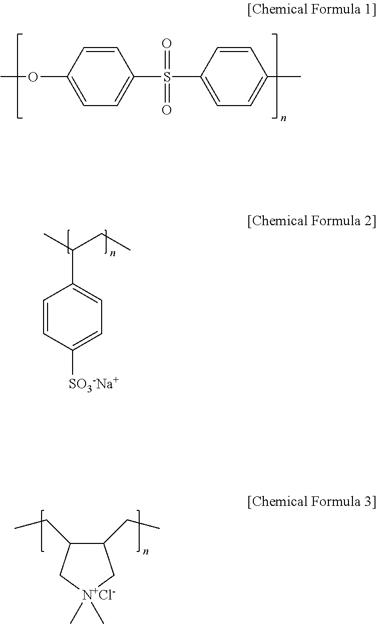

Functionalization of Multi-Walled Carbon Nanotube

Functionalization of a multi-walled carbon nanotube was performed by a method known in the art. The functionalized multi-walled carbon nanotube (f-MWCNTs) was analyzed by transmission electron microscopy (TEM), JEM-2100, JEOL, Japan, and the functionalization group of the multi-walled carbon nanotube was measured by Fourier-transform infrared spectroscopy (FTIR-460 plus, JASCO, Japan).

Manufacture of Polyelectrolyte Multilayer Membrane and Property Thereof

After an aqueous ethanol solution (20 vol %) was added to f-MWCNTs, followed by ultrasonic treatment for 30 minutes, a homogeneous PSS solution (1 mg/mL) containing 1 wt % of (CNT/polymer) MWCNTs was prepared, followed by ultrasonic treatment for 10 minutes, and the PSS aqueous solution and MWCNTs were mixed together. Then, deionized water was added to PDDA polymer to prepare a PDDA aqueous solution (1 mg/mL) and an additional pH controlling process was not performed.

Before performing a depositing process, in order to completely remove a wetting agent of a separator, the PES substrate was immersed into deionized water at 25 for 24 hours, wherein the deionized water was exchanged for each 3 hour. A PES separator was prepared by using a holder so that only one side of the separator contacts a solution.

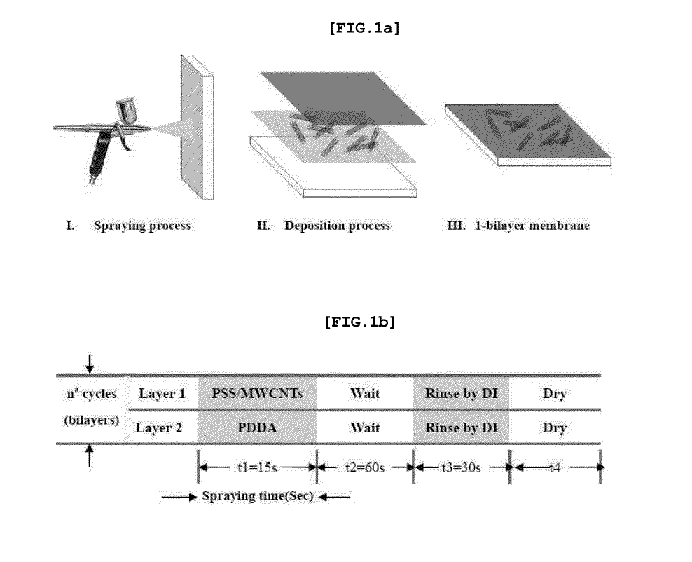

In manufacturing a polyelectrolyte multilayer membrane using a spray-assisted layer-by-layer (LBL) method, a spray gun (GP-1, 0.35 mm nozzle diameter, Fuso SEIKI Co., Ltd., Japan) was used with compressed air at 20 psi. The above-described method was shown in FIG. 1, wherein the membrane manufactured by using the method was represented by PES—(PSS/MWCNTs-PDDA)ₙ (for example: n=3.5 and 6.5).

An nth layer of the PSS/MWCNTs-PDDA thin membrane was formed on the PES separator. Spraying was initiated with PSS/MWCNTs on the PES substrate through hydrogen bonding or/and hydrogen-hydrophobic interaction, and the positive PDDA was interacted with the PSS/MWCNTs layer by electrostatic attraction and van der Waals force. All separators were prepared just before being used.

Analysis of Polyelectrolyte Multilayer Membrane

A surface of the separator was measured using scanning electron microscope (SEM) S-4700, Hitachi, Japan, and was analyzed by Fourier-transform infrared spectroscopy (FTIR) Varian 660-IR, Varian, USA. Surface roughness of the separator was measured using atomic force microscope (AFM) XE-100, PSIA, Korea in contact mode at an interval of 2 μm×2 μm.

Anti-Fouling Ultrafiltration Test

An ultrafiltration test was performed by a cross-flow filtration system manufactured at first hand and having a temperature controller, a flow meter, and a pressure gauge mounted therein. Every filtration membrane was stabilized for 4 hours so that a transmembrane pressure (TMP) was 0.41 Mpa and was controlled to be 0.35 Mpa. In order to evaluate anti-fouling properties of the membrane, the membrane was washed with water at a flow rate of 36 L/h for 20 minutes and was treated with 1 mg/mL BSA aqueous solution at 25±1 for 1 hour, and pH was maintained to be 7 using a phosphorus buffer (10 mM).

Water flux was determined using a new separator (Jwv), a polluted separator (Jpf) filtering BSA for 1 hour, and a pure separator (Jwp) washed with water.

$$J = \frac{V}{A Δ t} \qquad [ Equation 1 ]$$

In Equation 1, V is an amount (L) of permeated water, A is a region (1.856×10⁻³ m²) of an effective separator, and Δt is a permeation time (h). At the same time, flow rate ratio (FRR) and total flux loss (Rt) may be calculated by using the following Equations to measure a fouling resistance property of the separator. In the following Equations, R may be calculated by the following Equation 3, and in Equation 4, Cp and Cf mean concentrations of supplied BSA and permeated BSA, respectively:

$$\begin{matrix}FRR ( \% ) = ( \frac{Jwp}{Jwv} ) \times 100 \% & [ Equation 2 ] \\ Rt ( \% ) = ( \frac{Jwv - Jpf}{Jwv} ) \times 100 \% & [ Equation 3 ] \\ R ( \% ) = ( 1 - \frac{Cp}{Cf} ) \times 100 \% & [ Equation 4 ]\end{matrix}$$

Property of Functionalized Multi-Walled Carbon Nanotube

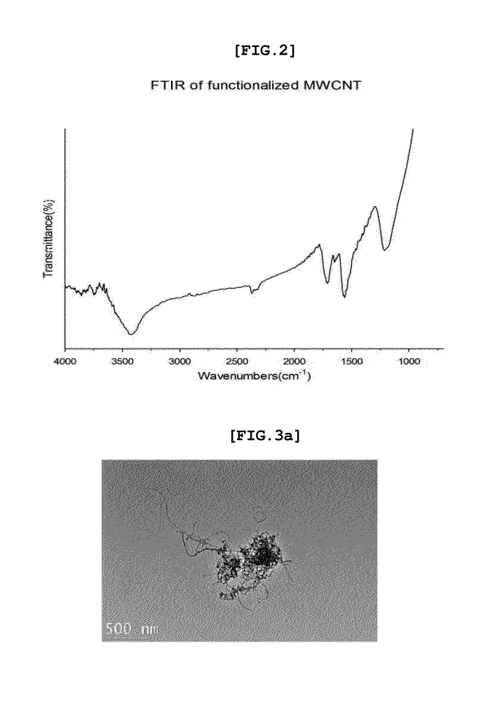

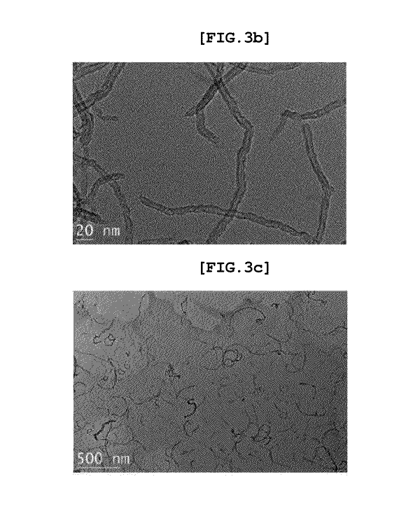

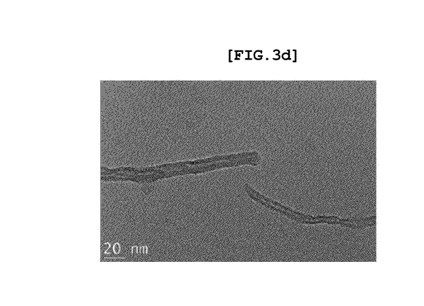

Fourier-transform infrared (FTIR) spectrum of a functionalized multi-walled carbon nanotube was shown in FIG. 2. An absorption band around 3416 cm⁻¹ was resulted from —OH group. Meanwhile, an absorption band around 1713 and 1647 cm⁻¹ was resulted from C═O stretching vibration. Absorption bands around 1563 and 1214 cm⁻¹ show a C═C ring stretching and —C—O group of the multi-walled carbon nanotube, respectively. Whether or not the multi-walled carbon nanotube is chemically modified by a mixing acid and functionalized with hydroxyl group and carboxyl group may be appreciated by Fourier-transform infrared spectroscopy (FTIR) spectrum.

Transmission electron microscope (TEM) images show modification of multi-walled carbon nanotube before and after being functionalized. In TEM of the multi-walled carbon nanotube before being functionalized, entangled and twisted ropes are observed, which is not sufficient for being commercially used. After the multi-walled carbon nanotube was functionalized, both ends thereof were open and a length thereof was shortened to be 400 nm, and the functionalized multi-walled carbon nanotube was easily dispersed into an aqueous solution in the presence of ethanol.

Analysis of Membrane Property

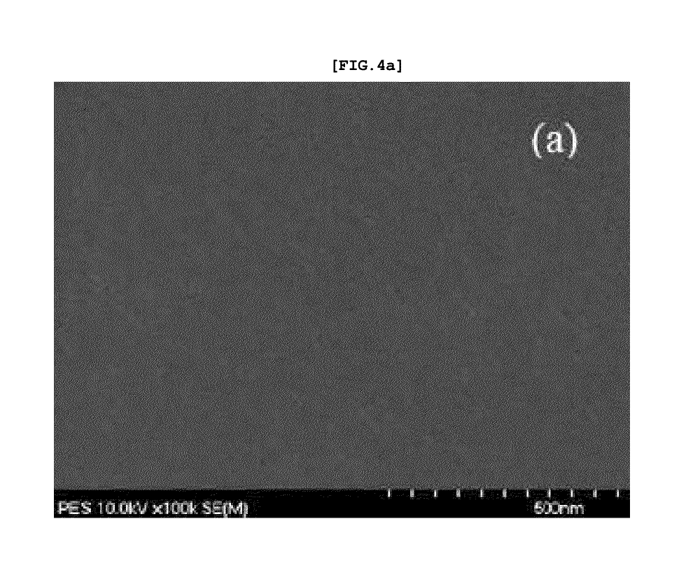

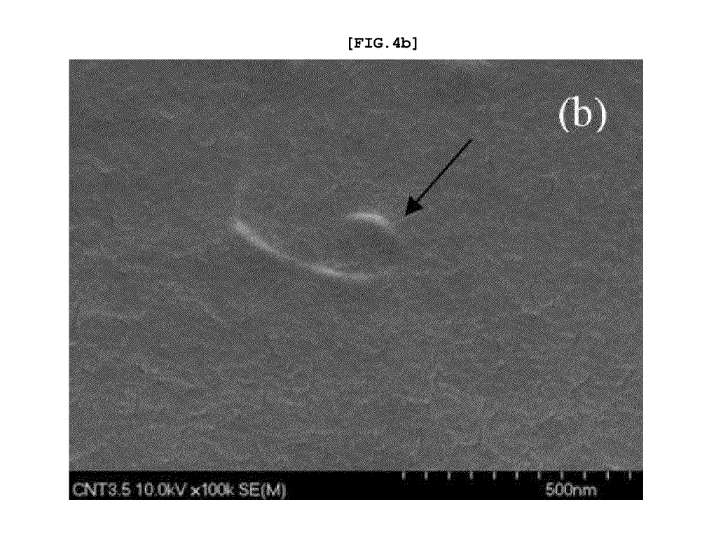

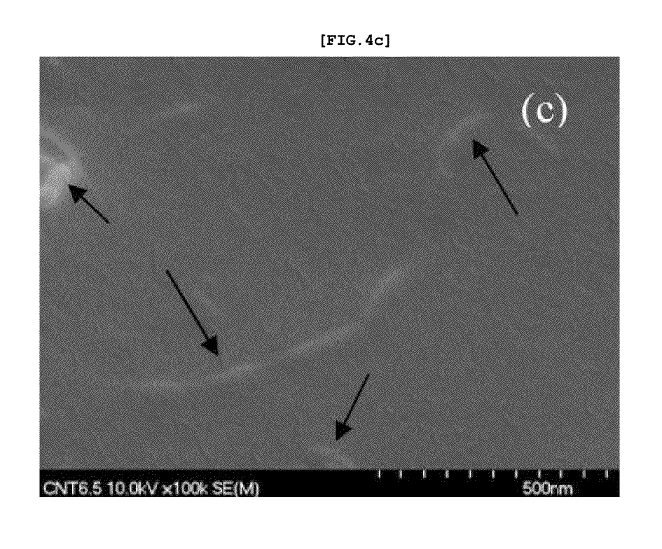

FIG. 4 shows surfaces of the separator. It could be confirmed that 3.5 and 6.5 bilayers were deposited and then the carbon nanotube was deposited on the surface of the PES separator, wherein the 6.5 bilayer had high density of carbon nanotube.

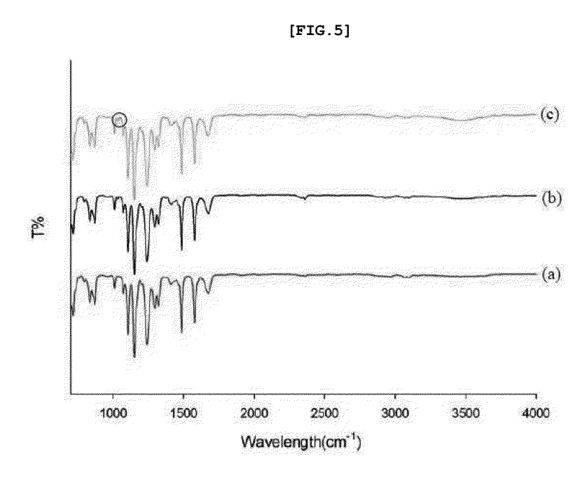

Fourier-transform infrared spectroscopy (FTIR) spectrum of the separator was shown in FIG. 5. Peaks at 1010, 1484 and 1577 cm⁻¹ indicated vibrations of aromatic rings present in PES and PSS. Peak at 3464 cm⁻¹ indicated superposition vibrations of —OH and N—H groups, and Peak at 1033 cm⁻¹ was resulted from vibrations of SO₃²⁻ group of PSS, and intensity was increased by an increase in the number of bilayers. It was confirmed from the FTIR spectrum that the separator was successfully manufactured.

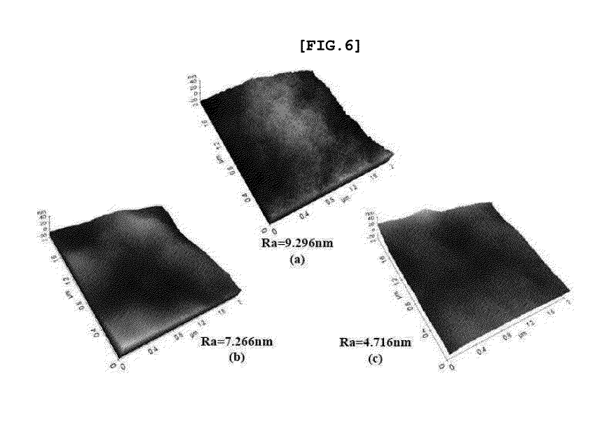

AFM results of FIG. 6 show modification of PES separator before and after being surface-modified. Deposition of the PES separator of the polyelectrolyte/multi-walled carbon nanotube on the surface of the separator provided a smooth surface as compared to the non-deposited PES separator, and the PES-(PSS/MWCNTs-PDDA)_{6.5} separator had the lowest roughness as compared to the other separators.

Anti-Fouling Ultrafiltration Test

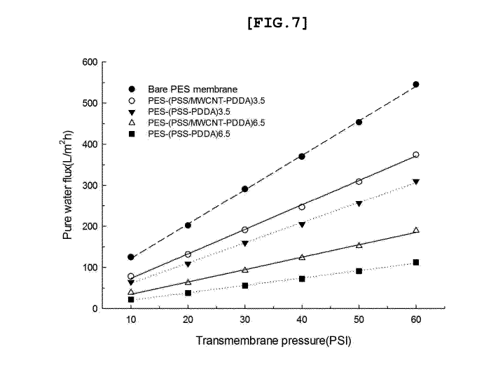

An ultrafiltration is a pressure-driven process, FIG. 7 shows a linear relationship between pure water stream and transmembrane pressure of the separator. Meanwhile, a successive deposition of the polyelectrolyte multilayer on the PES substrate depending on a decrease in a flow in addition to additional bilayer deposition on the PES substrate was suggested.

In the combination of the functionalized multi-walled carbon nanotube, an increase in pure water flow of the prepared separator is due to an empty space formed between polymer chain fragment and the functionalized multi-walled carbon nanotube, which is interested. In addition, the multi-walled carbon nanotube having open ends contributes to a route in which water molecules are easily entered and passed therethrough.

The anti-fouling property of the separator was evaluated by the total flow loss and flow rate ratio (FRR). After deposition of the 6.5 bilayer, the total flow loss was 28%, which was decreased than 64% of the non-deposited PES separator. In addition, the FRR after deposition of the 6.5 bilayer was 88%, meanwhile, the FRR of the non-modified PES separator was 51%. The results were identical to the prior research in which the PES separator modified by PSS has an improved anti-fouling property.

Total flow loss Rt, flow rate ratio, Reversible ratio (Rᵣ, and irreversible ratio (Rᵢᵣ) ratio may be defined by the following equations:

$$\begin{matrix}Rr = ( \frac{Jwp - Jpf}{Jwv} ) \times 100 \% & [ Equation 5 ] \\ Rir = ( \frac{Jwv - Jwp}{Jwv} ) \times 100 \% & [ Equation 6 ]\end{matrix}$$

As shown in the following Table 1, an increase in bilayer was significantly decreased at an irreversible ratio and slightly increased in a reversible ratio and rejection.

Basically, since a molecular weight of the BSA is significantly larger than that of MWCO of a test separator, the rejection of the BSA was controlled with size-exclusion. An interaction between charged foulants and the separator may be decreased by reinforcing electrostatic repulsion through change in surface charges of the separator. Introduction of negatively charged f-MMWCT to the polyelectrolyte multilayer membrane provided strong negatively charged density on a surface of the separator, wherein the pH is higher than an isoelectric point, and BSA showed a negative charge at pH 7.

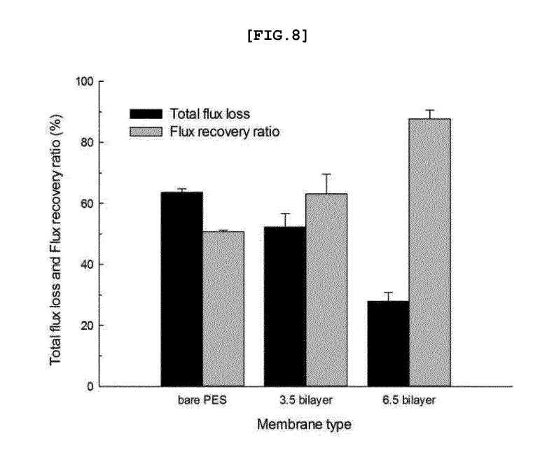

The AFM image of an upper surface showed a smooth surface after deposition, which is good for anti-fouling. Therefore, FIG. 8 and Table 1 show that an increase in deposited layers may obtain high Rt, Rir, and FRR. Increased BSA removal may be explained by a size interception and ion repulsion. Therefore, a prepared separator surface is indirectly coupled to or loosely adhered to the BSA. The following Table 1 shows fouling ratios of the separators manufactured for an anti-fouling test.

TABLE 1

| | Fouling ratios | | |
|---|---|---|---|
| | of BSA (%) | | |
| Membrane type | Rir | Rr | Rejection (%) |
| Bare PES | 49.3 ± 0.5 | 14.3 ± 0.7 | 99.78 ± 0.07 |
| PES-(PSS/MWCNT-PDDA)3.5 | 36.9 ± 6.5 | 15.4 ± 2.0 | 99.84 ± 0.12 |
| PES-(PSS/MWCNT-PDDA)6.5 | 12.3 ± 2.9 | 15.5 ± 0.1 | 99.90 ± 0.08 |

As described above, with the spray-assisted layer-by-layer (LbL) method according to various embodiments of the present invention, PES-polyelectrolyte/MWCNTs separator may be manufactured, and in this case, time is saved, mass-production is possible, and the separator according to the present invention may be used in various fields.

In addition, deposition of 3.5 and 6.5 bilayers to the polyelectrolyte/MWCNTs on the PES substrate may provide the separator having excellent anti-protein-fouling property and flux-recovery property, wherein the separator is recycled and utilized by simply being rinsed with water several times.

The ultra-thin composite separator appropriate for ultrafiltration and nanofiltration may be easily manufactured. In particular, the multi-walled carbon nanotube composite polyelectrolyte (PEMs) membrane may be formed on the polyethersulfone (PES) porous support membrane using the spray-assisted layer-by-layer (LBL) method. It is expected that the coating layer of the separator included in the present invention may increase membrane pollution-reduction performance.

The multilayer membrane according to various embodiments of the present invention may have excellent (i) flux property, (ii) anti-fouling (in particular, anti-protein-fouling) property, (iii) flux recovery property by the simple water cleaning process even after the membrane is fouled.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A multilayer membrane comprising:
a substrate; and
a first layer to a n^{th} layer adjacently formed on the substrate,
wherein the first layer to the n^{th} layer formed on the substrate are formed by a layer-by-layer assembly method;
the adjacent two layers are bound to each other by one or two or more kinds of actions selected from hydrophobic interaction. hydrophilic interaction, hydrogen bonding, electrostatic attraction (or adsorption) and van der Waals force; and
at least one of the first layer to the n^{th} layer formed on the substrate contains carbon nanotube (CNT).

2. A multilayer membrane comprising:
a substrate; and
a first layer to a n^{th} layer adjacently formed on the substrate,
wherein the first layer to the n^{th} layer formed on the substrate are formed by a layer-by-layer assembly method;
the adjacent two layers are bound to each other by one or two or more kinds of actions selected from hydrophobic interaction or hydrophilic interaction, hydrogen bonding, electrostatic attraction (or adsorption) and van der Waals force;
at least one of the first layer to the n^{th} layer formed on the substrate contains carbon nanotube (CNT); and
the layer-by-layer assembly method is performed by spraying a solvent or a dispersion of materials forming each layer on a target surface.

3. The multilayer membrane of claim 1, wherein in the first layer to the nth layer formed on the substrate, two polymer layers which are an A layer and a B layer are repeatedly formed alternately.

4. The multilayer membrane of claim 1, wherein in the first layer to the n^{th} layer formed on the substrate, three polymer layers which are an A layer, a B layer, and a C layer are repeatedly formed alternately.

5. The multilayer membrane of claim 3, wherein in the case in which the repeatedly and alternately formed layers are two polymer layers, carbon nanotube (CNT) is contained in at least any one of the A layer and the B layer.

6. The multilayer membrane of claim 4, wherein in the case in which the repeatedly and alternately formed layers are three polymer layers, carbon nanotube (CNT) is contained in at least any one of the A layer, the B layer and the C layer.

7. The multilayer membrane of claim 5, wherein in the case in which the repeatedly and alternately formed layers are two polymer layers, carbon nanotube (CNT) is contained in only one of any one of the A layer and the B layer.

8. The multilayer membrane of claim 6, wherein in the case in which the repeatedly and alternately formed layers are three polymer layers, carbon nanotube (CNT) is contained in only one of any one of the A layer, the B layer and the C layer.

9. The multilayer membrane of claim 2, wherein a content of the carbon nanotube (CNT) in the CNT-containing layer is 0.1 to 5 wt %.

10. The multilayer membrane of claim 1,
wherein the multilayer membrane is an ultrafiltration membrane.

11. The multilayer membrane of claim 1
wherein the substrate is made of PES, the first layer is made of PSS containing MWCNT, and the second layer is made of PDDA; and
the first layer made of PSS containing MWCNT and the second layer made of PDDA are repeatedly stacked alternately on the substrate.

12. A multilayer membrane comprising:
a substrate; and
a first layer to a nth layer adjacently formed on the substrate,
wherein the first layer to the nth layer formed on the substrate are formed by a layer-by-layer assembly method;
the adjacent two layers are bound to each other by one or two or more kinds of actions selected from hydrophobic interaction or hydrophilic interaction, hydrogen bonding, electrostatic attraction (or adsorption) and van der Waals force;
at least one of the first layer to the nth layer formed on the substrate contains carbon nanotube;
the substrate contacts a post-permeation filtrate filtering and permeating the multilayer membrane;
the uppermost layer disposed at a side opposite to the substrate contacts a pre-permeation filtrate containing a target material to be filtered out by the multilayer membrane;
in the case in which a fouling-induced material contained in the pre-permeation filtrate and adsorbed onto the multilayer membrane to induce a fouling of the membrane is negatively charged, the uppermost layer disposed at a side opposite to the substrate is also negatively charged; and
in the case in which the fouling-induced material is positively charged, the uppermost layer is also positively charged.

13. The multilayer membrane of claim 12, wherein in the case in which fouling-induced material is negatively charged, the uppermost layer is made of PSS/MWCNT, and in the case in which fouling-induced material is positively charged, the uppermost layer is made of PDDA.
